(19) United States
(12) Patent Application Publication
(10) Pub. No.: US 2023/0239304 A1
(43) Pub. Date: Jul. 27, 2023

(54) USER DEVICE CONFIGURATION

(71) Applicant: BRITISH TELECOMMUNICATIONS PUBLIC LIMITED COMPANY, London (GB)

(72) Inventors: Gery DUCATEL, London (GB); Mamun ABU-TAIR, London (GB); Zhan CUI, London (GB); Joseph RAFFERTY, London (GB); Hanif ULLAH, London (GB); Aftab ALI, London (GB); Philip MORROW, London (GB)

(21) Appl. No.: 18/002,706

(22) PCT Filed: Jun. 15, 2021
(86) PCT No.: PCT/EP2021/066104

§ 371 Date: Dec. 21, 2022

(30) Foreign Application Priority Data
Jun. 25, 2020 (GB) 2009726.7

(51) Int. Cl. H04L 9/40

(52) U.S. Cl. CPC H04L 63/102; H04L 63/20

(57) ABSTRACT

A method of configuring a user device. The method includes sending, from the user device to a node of a distributed ledger network (DLN), the node configured to store a distributed ledger of the DLN, a request for characteristic data indicative of a characteristic associated with a service provider, receiving, at the user device, a response from the node of the DLN in response to the request, and configuring a functionality of the user device accessible to the service provider, based at least in part on the response from the node of the DLN. Further aspects relate to a data processing system, a network, and a method of operating a network.

### PRIORITY CLAIM

The present application is a National Phase entry of PCT Application No. PCT/EP2021/066104, filed Jun. 15, 2021, which claims priority from GB Patent Application No. 2009726.7, filed Jun. 25, 2020, each of which is hereby fully incorporated herein by reference.

### TECHNICAL FIELD

The present disclosure relates to configuring a user device.

### BACKGROUND

An increasing number of devices are being provided with the means to communicate data. The Internet of Things (IoT) is a network of user devices such as home appliances, vehicles and other items embedded with electronics, software, sensors, actuators, and/or connectivity which enable these devices to connect with each other and/or other computer systems and exchange data. Premises such as homes and workplaces are increasingly becoming ‘smart’ environments which support IoT device communication over a network.

Individuals occupying smart environments are becoming increasingly accustomed to the convenience provided by their local IoT and familiar with opportunities to perform tasks with the aid of connected devices. However, connecting a user device to a network risks the security of the user device and the network being compromised.

### SUMMARY

It is desirable to at least alleviate some of the aforementioned problems.

According to a first aspect of the present disclosure, there is provided a method of configuring a user device, the method comprising: sending, from the user device to a node of a distributed ledger network (DLN), the node configured to store a distributed ledger of the DLN, a request for characteristic data indicative of a characteristic associated with a service provider; receiving, at the user device, a response from the node of the DLN in response to the request; and configuring a functionality of the user device accessible to the service provider, based at least in part on the response from the node of the DLN.

In some examples, configuring the functionality of the user device accessible to the service provider comprises configuring a data access policy for access of the service provider to data captured by the user device.

In some examples, configuring the functionality of the user device accessible to the service provider comprises configuring a functionality access policy for access of the service provider to at least one function provided by the user device.

In some examples, configuring the functionality of the user device accessible to the service provider comprises configuring the user device such that a first functionality of the user device is accessible to the service provider and a second functionality of the user device, different from the first functionality of the user device, is inaccessible to the service provider.

In some examples, the user device comprises a sensor configured to capture sensor data indicative of at least one of: a feature of an environment of the user device or a feature of a user of the user device. In some of these examples, configuring the functionality of the user device accessible to the service provider comprises configuring the user device such that a first portion of the sensor data is accessible to the service provider and a second portion of the sensor data, different from the first portion of the sensor data, is inaccessible to the service provider.

In some examples, the characteristic comprises at least one of: a service provided by the service provider, compliance of the service provider with a technical standard, or compliance of the service provider with a legal requirement.

In some examples, the service provider is a first service provider, the functionality is a first functionality, and the method comprises configuring the user device to make a second functionality of the user device, different from the first functionality, accessible to a second service provider, different from the first service provider. In some of these examples, the method comprises configuring the user device to provide the first functionality to the first service provider with the user device connected to a first network via a first network device, and configuring the user device to provide the second functionality to the second service provider with the user device connected to a second network via a second network device.

In some examples, the response comprises the characteristic data, and the method comprises sending the characteristic data to a policy decision engine for determining the functionality of the user device to be made accessible to the service provider. In some of these examples, the method comprises the user device receiving configuration instructions from the policy decision engine to cause the configuring of the functionality of the user device accessible to the service provider.

In some examples, configuring the functionality of the user device accessible to the service provider comprises configuring the user device such that the functionality of the user device is accessible to the service provider upon compliance of the service provider with an accessibility condition. In some of these examples, the accessibility condition comprises connection of a computing system associated with the service provider, for communication with the user device, to a virtual private network (VPN) to which the user device is connected.

In some examples, the characteristic data is first characteristic data, the response from the node of the DLN comprises the first characteristic data, and the method comprises: receiving, at the user device, second characteristic data from the service provider, the second characteristic data indicative of the characteristic associated with the service provider; and configuring the functionality of the user device accessible to the service provider based at least in part on a comparison between the first characteristic data and the second characteristic data.

In some examples, the characteristic data is indicative of a certificate associated with the service provider. The certificate may be issued by a verification system configured to verify the characteristic associated with the service provider. The verification system may be associated with a regulatory authority.

In some examples, sending the request comprises sending the request via a network device, receiving the response comprises receiving the request via the network device, and the method comprises: the user device receiving network device authorization data from the network device for use in authorizing the network device; and the user device validating the network device authorization data against a version of the network device authorization data stored in the distributed ledger or a further distributed ledger. The network device authorization data may be indicative of a certificate associated with the network device. The network device authorization data may indicate that at least one of: a configuration of the network device complies with a technical standard or a configuration of the network device complies with a legal requirement. In some of these examples, the method comprises the user device validating the network device authorization data before configuring the functionality of the user device accessible to the service provider. The network device may comprise a gateway device. In some of these examples, the method comprises: the user device sending user attribute data representative of at least one attribute of at least one of the user device or the user to a verification system; and the user device receiving, from the verification system, user authorization data for use in authorizing the at least one of the user device or the user. The user device may send the user authorization data to the network device for use in authorizing the at least one of: the user device or the user.

According to a second aspect of the present disclosure, there is provided a data processing system comprising a processor configured to perform any of the methods according to the first aspect.

According to a third aspect of the present disclosure, there is provided a network comprising: a user device; and a node of a distributed ledger network (DLN), wherein the user device is configured to: send a request for characteristic data indicative of a characteristic associated with a service provider to the node; receive a response from the node of the DLN in response to the request; and configure a functionality of the user device accessible to the service provider, based at least in part on the response from the node of the DLN, and wherein the node of the DLN is configured to: receive the request from the user device; determine whether a distributed ledger of the DLN comprises the characteristic data; generate the response for sending to the user device, wherein the response is indicative of whether the distributed ledger comprises the characteristic data; and send the response to the user device.

According to a fourth aspect of the present disclosure, there is provided a method of operating a network comprising a user device and a node of a distributed ledger network (DLN), the method comprising: sending, from the user device to the node of the DLN, a request for characteristic data indicative of a characteristic associated with a service provider; determining, at the node of the DLN, whether a distributed ledger of the DLN comprises the characteristic data; generating, at the node of the DLN, a response indicative of whether the distributed ledger comprises the characteristic data; sending the response from the node of the DLN to the user device; and configuring a functionality of the user device accessible to the service provider, based at least in part on the response from the node of the DLN.

Examples herein relate to methods and/or apparatus substantially as herein described and/or as illustrated with reference to the accompanying drawings. Further examples herein relate to a computer program and/or a computer program product for carrying out any of the methods described herein and/or for embodying any of the apparatus features described herein, and a computer-readable medium storing thereon a program for carrying out any of the methods and/or for embodying any of the apparatus features described herein. Features described as being implemented in hardware may alternatively be implemented in software, and vice versa.

Yet further examples relate to a method of transmitting a signal, and a computer product having an operating system that supports a computer program for performing any of the methods described herein and/or for embodying any of the apparatus features described herein.

Any apparatus feature may also be provided as a corresponding operation of a method, and vice versa. As used herein, means plus function features may alternatively be expressed in terms of their corresponding structure, for example as a suitably-programmed processor.

Any feature in one aspect of the disclosure may be applied, in any appropriate combination, to other aspects of the disclosure. Any, some and/or all features in one aspect can be applied to any, some and/or all features in any other aspect, in any appropriate combination. Particular combinations of the various features described and defined in any aspects of the disclosure can be implemented and/or supplied and/or used independently.

As used throughout, the word ‘or’ can be interpreted in the exclusive and/or inclusive sense, unless otherwise specified.

### BRIEF DESCRIPTION OF THE DRAWINGS

Examples herein relate to methods and systems of configuring a user device, to a data processing system, to a network, and to a method of operating a network as described herein and/or substantially as illustrated with reference to the accompanying drawings. Examples are now described, with reference to the accompanying diagrammatic drawings, in which:

FIG. 1 is a schematic diagram of an example system comprising user devices.

FIG. 2 is a schematic diagram of an example system for configuring a user device.

FIG. 3 is schematic diagram of an example system for storing characteristic data associated with a service provider.

FIG. 4 is schematic diagram of an example system for authorizing a network device.

FIG. 5 is a schematic diagram showing internal components of an example data processing system.

### DETAILED DESCRIPTION

The following description is presented to enable any person skilled in the art to make and use the system, and is provided in the context of a particular application. Various modifications to the disclosed embodiments will be readily apparent to those skilled in the art.

Methods and systems in accordance with the present disclosure can be used to configure the functionality of a user device, such as an IoT device, that is accessible to a particular service provider, such as a given entity or organization. A request for characteristic data indicative of a characteristic associated with the service provider is sent from the user device to a node of a distributed ledger network (DLN). A response is received by the user device from the node of the DLN, e.g. providing the characteristic data, which may be in the form of a certificate attesting to a particular characteristic of the service provider. A functionality of the user device accessible to the service provider is configured, based at least in part on the response from the node of the DLN. In this way, the functionality of the user device can be adapted suitably for a given service provider, e.g. to allow or disallow the sharing of sensitive information, or functionality based on sensitive information, with a particular service provider. For example, this approach may be used to restrict the accessibility of certain functionality of the user device to service providers that are sufficiently secure, e.g. that comply with particular data security measures. The security of the user device, and data obtained by the user device, can thereby be enhanced with the methods herein.

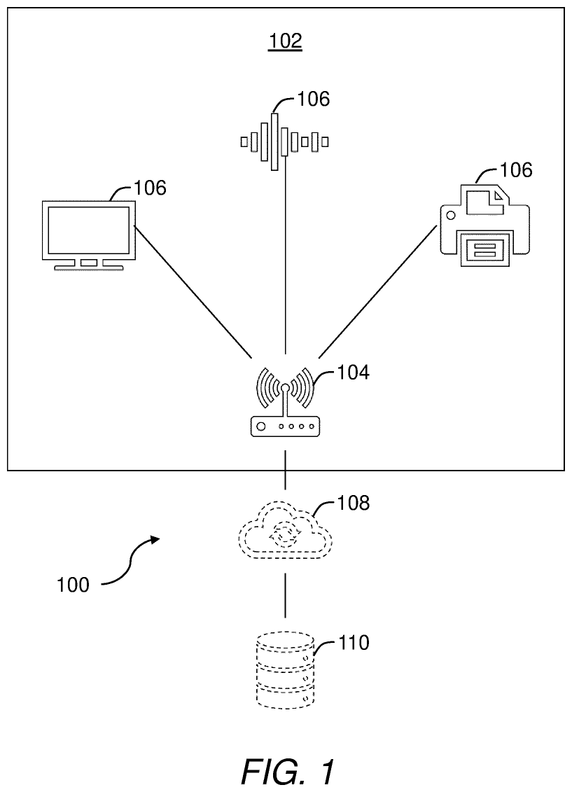

FIG. 1 illustrates an example system 100 in which the methods described herein can be employed. A local network 102 is provided by a network device. A network device is a device that provides an entry point to a network (in this case the local network 102) or that filters and/or routes network traffic, such as a router, gateway device, switch, hub, access point or an edge device (which may be or comprise a router or routing switch). In FIG. 1, the network device is a gateway device 104, but this is merely an example. The gateway device 104 allows data to flow between the local network 102 and a wider network, for example the Internet 108, in order to facilitate communication with a remote server 110, which in this case is associated with a service provider. The gateway device 104 may include various components in order to connect the local network 102 to the Internet 108, such as a router. Although only a single gateway 104 is shown in FIG. 1, the local network 102 could employ multiple access points and/or signal boosters to perform this function.

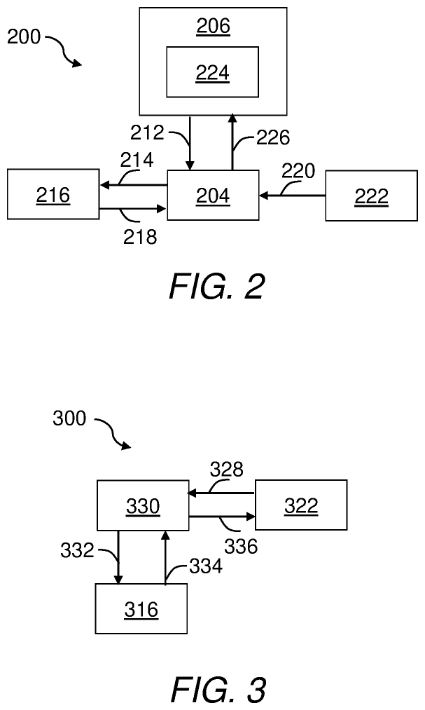

The methods herein (discussed in detail with reference to FIGS. 2 to 4) are for configuring a user device, to configure a functionality of the user device accessible to the service provider. A user device can for example include one or more of smart televisions (TVs), smart refrigerators, connected printers, smart lighting fixtures, smart thermostats, home security systems, smart watches, physiological or biometric sensors, and voice assistant devices. A user device may be a device to be included in the IoT, which may be referred to as an IoT device. In the example of FIG. 1, the functionality of each of a plurality of user devices 106 accessible to the remote server 110 of the service provider are suitably configured. The user devices 106 are connected to the gateway 104 through a wired and/or wireless connection. The functionality of the user devices 106 in this case are accessible to the remote server 110 of the service provider via the gateway 104, which communicates with the remote server 110 via the Internet 108.

FIG. 2 is a schematic diagram of an example system 200 for configuring a user device 206 (e.g. any one of user devices 106). The user device 206 is connected to a network via a network device 204 (e.g. a gateway device). The network may (although need not) be a local network (e.g. local network 102), such as a network associated with a limited area such as a residence, workspace, building or set of buildings. The user device 206 sends a request 212 to the network device 204 for characteristic data (discussed further below) indicative of a characteristic associated with a service provider. The user device 206 for example sends the request 212 in response to the user device 206 receiving a communication from the service provider (e.g. a computing device associated with the service provider, such as the remote server 110) requesting access to functionality of the user device 206.

The network device 204 sends a request 214 to a node 216 of a DLN, such as a blockchain network. In this case, the system 200 of FIG. 2 includes a network including the user device 206 and the node 216. The network of FIG. 2 also includes the network device 204, but this is merely an example. The node 216 is configured to store a distributed ledger of the DLN, and may be any suitable computing device for storing a distributed ledger. A ledger in examples herein is a digital ledger including a series of blocks, which generally grows over time as additional data is added to the ledger. Each block is linked to a previous block in the series using cryptographic hashing. Typically, each block includes a timestamp, transaction data (e.g. representing a data record), and a hash of the previous block. A hash function for performing cryptographic hashing may be considered to be a one-way function that maps a given input (such as a data record) to an output, typically of a fixed size. Such a function is one-way in that the input cannot be recovered from the output, even if the function itself is known. Chaining successive blocks cryptographically allows changes to an individual block to be readily detected by detecting a difference between the hash of the block and the hash of the block as stored in the subsequent block of the chain. Hence, to successively alter the data of a given block without detection, all subsequent blocks must also be altered, which is generally difficult to achieve undetected. Such a ledger is therefore resistant to tampering.

To further increase the resistance to tampering, the ledger is stored in a decentralized manner, i.e. it is a distributed ledger. The ledger is synchronized across a plurality of nodes of the DLN, including the node 216 of FIG. 2, so that each of the nodes stores a separate copy of the ledger. This removes a centralized point of failure from the DLN, increasing the immutability of the data. For example, to alter the data of a given block, a majority of nodes of the DLN must consent to the alteration, and with the alternation of all subsequent blocks of the ledger. The DLN, and hence the distributed ledger stored within the DLN, is therefore secure by design, as consensus will typically not be achieved for attempts to maliciously alter the distributed ledger.

The request 214 for the characteristic data may be in any suitable form. In some cases, the request 214 includes a request, based on an identifier indicative of a block of the distributed ledger in which the characteristic data is stored, for block data representative of at least part of the block. This facilitates retrieval of the characteristic data from the distributed ledger. In such cases, the identifier may be received at the network device 204 from the user device 206, either as part of the request 212 sent from the user device 206 to the network device 204 or as a separate message or other communication. The identifier may be a block identifier (sometimes referred to as a block ID) representing the identity of the block of the distributed ledger in which the characteristic data is stored. In other cases, though, the identifier may indirectly indicate the block of the distributed ledger in which the characteristic data is stored. For example, the identifier may represent a transaction identifier (sometimes referred to as a transaction ID), allowing a block including a transaction including the characteristic data to be identified.

The sending of the request 212 from the user device 206 to the network device 204, and the request 214 from the network device 204 to the node 216 may be considered to correspond to the sending of a request from the user device 206 to the node 216 for the characteristic data. In other words, such a request may be sent from the user device 206 to the node 216 via at least one further device, such as the network device 204.

The request is for characteristic data associated with the service provider, indicative of a characteristic associated with the service provider. The characteristic is for example an attribute or other feature associated with the service provider, which is useable to determine functionality of the user device 206 to be made accessible to the service provider. The characteristic may be or include a feature of a service provided by the service provider or a device or system associated with the service provider.

In one case, the characteristic is indicative of a service or other activity provided by the service provider. The functionality provided by the user device 206 can therefore be configured differently for service providers providing different activities. As an example, if the user device 206 is a smart watch arranged to capture biometric data of a user, the user device 206 may be configured to provide a greater proportion of the biometric data to a service provider that is a healthcare organization than to a service provider that provides an activity tracking service. For example, the additional biometric data provided to the healthcare organization may be provided to facilitate the provision of healthcare to the user. However, this portion of the biometric data may not be needed in order to perform activity tracking (e.g. if it relates to physiological aspects of the user that the activity tracking service does not track over time). Hence, by configuring the user device 206 so that this portion of the biometric data is not sent to the activity tracking service, data security can be improved by reducing sharing of sensitive user data. Furthermore, this approach allows a multi-functional user device 206 to be provided, e.g. that is capable of obtaining different sets of data for different purposes. Such a user device 206 is for example more flexible than a user device that is only operable for a single purpose, but without compromising data security.

In another case, the characteristic additionally or alternatively indicates compliance of the service provider with a particular requirement, such as a technical standard and/or with a legal requirement. A technical standard may be a standard set by a standard-setting body. Satisfying a particular technical standard for example indicates that the service provider (or a system associated with the service provider) meets a given standard, such as a security standard. A legal requirement may be set by any suitable legal or other regulatory body, which may be a national legal body or an international legal body. Compliance with a legal requirement indicates that the service provider (or a system associated with the service provider) complies with a given legal rule or other regulation, such as the General Data Protection Regulation (GDPR). For example, the characteristic of the service provider may represent an indication that the service provider complies with an International Organization for Standardization (ISO) standard, such as the ISO/IEC 27001 standard, which indicates that an information security management system of the service provider complies with certain security requirements, and is therefore likely to be secure. Hence, the user device 206 can provide certain functionality (such as that based on the processing or sending of sensitive data to the service provider) to the service provider without unduly exposing the user device 206 (and hence the network to which the user device 206 is connected) to security risks. It will be appreciated that the characteristic may include a single characteristic (e.g. indicating compliance of the service provider with a single technical standard) or a plurality of requirements (e.g. indicating compliance of the service provider with both a technical standard and a legal requirement). The characteristic associated with the service provider may be time-varying, e.g. to reflect changes in or newly created technical standards and/or legal requirements, or to reflect changes in systems or activities of the service provider.

It is to be appreciated that the service provider may be considered to comply with a particular requirement, such as a technical standard or a legal requirement, where a configuration of a computing system associated with the service provider, and which the user device 206 is to communicate with, complies with a predefined configuration. The predefined configuration may be a hardware and/or software configuration. For example, the computing system may be considered to comply with such a requirement where the computing system includes particular anti-virus, anti-malware or firewall software, or where the computing system has received a particular software update (sometimes referred to as a patch) to reduce a vulnerability of the computing system to an attack.

In the example of FIG. 2, the characteristic data is derived from or otherwise represents a certificate indicative of a certificate associated with the service provider, e.g. a certificate indicating compliance with a particular technical standard and/or legal requirement, and/or certifying a service provided by the service provider. Such a certificate was previously issued by a verification system configured to verify the characteristic associated with the service provider, e.g. a verification system configured to verify that the service provider complies with a particular requirement or offers a particular service. This is explained further with reference to FIG. 3. In other cases, though, the characteristic data may represent a different indicator of the characteristic of the service provider than a certificate. For example, the characteristic data may represent a flag or code (which may e.g. be alphabetical, numerical or alphanumerical) indicating a particular characteristic of the service provider.

The distributed ledger may be a public distributed ledger, e.g. stored in a public DLN. This facilitates the use of existing public distributed ledgers, which simplifies the use of the methods herein. Methods herein can be implemented securely despite the use of a public DLN. For example, the characteristic data may be encrypted or otherwise cryptographically secured prior to storage in the distributed ledger. As an example, a cryptographic hash, or otherwise cryptographically secure version, of a certificate associated with the service provider may be stored in a distributed ledger rather than the certificate itself. In this way, the characteristic data may be derived from the certificate rather than representing the certificate itself.

After receiving the request 214 for the characteristic data, the node 216 of the DLN determines whether the distributed ledger of the DLN includes the characteristic data. The node 216 then generates a response, which for example indicates whether the distributed ledger includes the characteristic data, and sends the response 218 to the network device 204. A functionality of the user device 206 is then determined, based at least in part on the response 218 from the node 216. The determination of the functionality of the user device 206 is performed by the network device 204 in the example of FIG. 2, but may be performed by a further computing device in other examples (or by the user device 206 itself). For example, the network device 204 may send the response 218 (and, in some cases, further data representative of at least one attribute of the user device 206 and/or the network device 204) to the further computing device, such as a remote server system, and receive a response from the further computing device indicative of the functionality the user device 206 is to be configured to make accessible to the service provider and/or including instructions for configuring the user device 206 to make the functionality accessible to the service provider.

In some cases, the response 218 from the node 216 indicates that the distributed ledger lacks the characteristic data. This may be the case where the service provider has not yet been certified or where the service provider does not have a particular characteristic (e.g. if the service provider fails to comply with a particular requirement). The response 218 may be a negative or null response, indicating that the characteristic data has not been located. Alternatively, the response 218 may be a lack of communication from the node 216 for a given period of time (which may be considered to correspond to a timeout). In these cases, it may be determined to deny access to the functionality of the user device 206 to the service provider. The user device 206 may hence refuse to connect to a computing system associated with the service provider or may refuse to provide data to the computing system associated with the service provider.

In other cases, the response 218 indicates that the distributed ledger includes the characteristic data. The response 218 may indicate that the distributed ledger includes the characteristic data by sending the characteristic data to the network device 204 or by providing an indication to the network device 204 that nevertheless indicates that the distributed ledger includes the characteristic data, without providing the characteristic data itself. In these cases, the functionality of the user device 206 to provide to the service provider may then be determined at least partly based on the response 218, either by the network device 204 or a further computing device, such as the user device 206.

In some cases, the functionality of the user device 206 to be made accessible to the service provider is determined solely based on the response 218. In other cases, though, the configuring of the user device 206 to make the functionality accessible to the service provider may be performed based on the response 218 and at least one other factor. For example, the functionality the user device 206 is to provide may be determined based on the response 218 (e.g. if the response 218 indicates that the service provider is associated with a particular characteristic). However, the functionality is not made accessible to the service provider until the service provider complies with an accessibility condition, which is for example a further security condition that must be satisfied by the service provider (e.g. by a computing system associated with the service provider) in order for access to the functionality to be granted. This further improves security, by allowing further security conditions to be imposed on the service provider. In one case, the accessibility condition is satisfied if the computing system associated with the service provider, which is arranged to communicate with the user device 206, is connected to a virtual private network (VPN) to which the user device 206 is connected, although this is merely an example.

In one example, the response 218 from the node 216 includes the characteristic data, which may be referred to as first characteristic data. In examples, the characteristic data obtained from the distributed ledger is digitally signed by a verification system configured to verify the characteristic associated with the service provider. The verification system is for example associated with a regulatory authority, which is trusted to issue characteristic data (e.g. representative of a certificate) attesting to a particular characteristic of the service provider. This allows the issuing of the characteristic data by the verification system to be verified by a verifying device, such as the network device 204, the user device 206 and/or a further computing system. For example, configuring the functionality of the user device 206 to be made accessible to the service provider may be based at least in part on verifying that the digital signature of the characteristic data is associated with the verification system. In one such example, the verification system has issued a certificate attesting to a characteristic of the service provider. The certificate is digitally signed by the verification system to generate a digital signature representing a version of the certificate (e.g. a cryptographically secure version of the certificate, such as a hash of the certificate) after encryption. The version of the certificate is encrypted using a private key associated with the verification system to obtain the digital signature. In these cases, a verifying device can obtain a copy of a public key associated with the verification system (which forms an asymmetric key pair with the private key). The verifying device can then decrypt the encrypted digital signature with the public key associated with the verification system to obtain the decrypted digital signature, which e.g. represents a version of the certificate, and determine that the digital signature of the certificate is associated with the verification system. In this way, the authenticity of the characteristic data can be verified. In some cases, the user device 206 is configured to make particular functionality accessible to the service provider if the characteristic data is received and if the digital signature of the characteristic data is successfully verified. It is to be appreciated that a similar approach may be used to verify the digital signature of the characteristic data in other examples in which the characteristic data represents a different indication of the characteristic associated with the service provider than a certificate, e.g. a hash of a certificate (discussed further below) or a flag or code.

In some examples, such as that of FIG. 2, a verifying device (which in the example of FIG. 2 is the network device 204) also receives second characteristic data 220 from a computing system 222 associated with the service provider (e.g. the remote server 110). The second characteristic data may be digitally signed by the computing system 222. A digital signature of the second characteristic data may be verified in a similar way to verification of the digital signature of the first characteristic data, but using a public key associated with the computing system 222 rather than the verification system.

In FIG. 2, the second characteristic data 220 corresponds to the first characteristic data but is received from the computing system 222 associated with the service provider rather than the node 216 of the DLN, and may e.g. represent or be derived from a certificate attesting to the characteristic. Such a certificate may include information identifying the certificate, the computing system 222, the service provider and/or the verification system.

In FIG. 2, the functionality of the user device 206 to be made accessible to the service provider is configured based at least in part on a comparison between the first characteristic data and the second characteristic data. The second characteristic data provided by the service provider, via the computing system 222, is generally easier for a malicious party to modify than the first characteristic data, which is stored securely in the distributed ledger. Hence, by verifying the second characteristic data against the first characteristic data, e.g. by comparing the first and second characteristic data, it can be determined that the second characteristic data is reliable, and that the service provider does indeed have the characteristic indicated by the second characteristic data. However, if the comparison between the first characteristic data and the second characteristic data indicates that the first characteristic data differs from the second characteristic data, this may indicate that the second characteristic data has been tampered with, and that a security of the service provider has been compromised. In such cases, the user device 206 may be configured to deny the service provider access to a functionality of the user device 206, or the functionality of the user device 206 made accessible to the service provider may be restricted to non-sensitive functionality (e.g. based on data that can be shared publicly).

In examples, the first characteristic data and the second characteristic data each represent a cryptographically secure version, e.g. a cryptographic hash, of an indication of the characteristic associated with the service provider, such as a hash of a certificate. The cryptographically secure versions represented by the first and second characteristic data in these examples are obtained using the same cryptographic function, e.g. the same hashing function. In this way, the first characteristic data and second characteristic data can be transferred between the various components of the example system 200 without risking exposure of the characteristic itself, which may be considered sensitive information. In these examples, the first characteristic data and the second characteristic data may be obtained using a one-way function, which cannot be reversed. The underlying indications themselves are hence unobtainable from the first characteristic data and the second characteristic data, e.g. to verify that the indications are correct. Nevertheless, such an approach may be used where the verification system that issued the first characteristic data (e.g. a regulatory authority) is considered sufficiently trustworthy.

If the characteristic of the service provider is successfully verified (e.g. by receiving an indication from the node 216 that the distributed ledger includes the characteristic data, verifying a digital signature of first and/or second characteristic data, and/or verifying that the first and second characteristic data match), it is determined that the service provider does have a particular characteristic. The user device 206 is then configured to make functionality of the user device 206 accessible to the service provider based on what the particular characteristic is. In other words, approaches such as FIG. 2 involve verifying the accuracy of a claim by the service provider to have a particular characteristic. If this claim is verified, the user device 206 is then configured according to the (verified) characteristic of the service provider.

The functionality of the user device 206 accessible to the service provider may be configured in various different ways. For example, a data access policy for access of the service provider to data captured by the user device 206 may be configured. The data access policy for example allows the user device 206 to provide selective access to data to particular service providers, without providing access to the data to other service providers. In this way, data transmission can be controlled in a secure manner, to avoid sharing data unnecessarily. For example, data captured by the user device 206 can be sent to service providers that are to use the data, e.g. to provide a given service, without sharing the data (or a portion of the data) with other service providers, who do not need the data.

In the example of FIG. 2, the user device 206 includes a sensor 224 configured to capture sensor data, such as sensor data indicative of a feature of an environment of the user device 206 and/or a feature of a user of the user device 206. For example, the sensor data may represent a feature of the environment, e.g. temperature, a feature of the user, e.g. a pulse rate or an electrocardiogram (ECG) of the user, or a condition resulting from an interaction between a person and the environment, e.g. whether a door has been opened. In this case, the user device 206 can be configured, based on the response 218 from the node 216 of the DLN, so that a first portion of the sensor data is accessible to the service provider and a second portion of the sensor data, different from the first portion of the sensor data, is inaccessible to the service provider. For example, where the first portion of the sensor data represents the user's pulse rate and the second portion of the sensor data represents an ECG of the user, the first portion of the sensor data may be provided to an activity tracking service provider. However, the second portion of the sensor data may not be provided to the activity tracking service provider if the activity tracking service provider does not offer the option of tracking a user's ECG.

In contrast, if the user device 206 is connected to a different service provider (which may be referred to as a second service provider) that does make use of ECGs (e.g. a healthcare provider), both the first and second portions of the sensor data may be provided to the second service provider. In this way, the user device 206 may provide a first functionality to a first service provider (which in this illustrative example is an activity tracking service provider) and a second, different, functionality to the second service provider (which in this illustrative example is a healthcare provider). It is to be appreciated that, in examples herein, the sending of different portions of data from the user device 206 to the service provider is to be considered to correspond to making a different functionality of the user device 206 accessible to a service provider.

In examples in which the user device 206 is configured to provide different functionality to different service providers, the user device 206 may provide a first functionality to the first service provider with the user device 206 connected to a first network via a first network device, which may be a network device associated with the first service provider (such as a gateway device located in premises owned or operated by the first service provider). The second functionality may similarly be provided to the second service provider with the user device 206 connected to a second network via a second network device. In this way, the functionality of the user device 206 can be configured suitable as the user device 206 is deployed in different environments, e.g. with the user device 206 connected to different networks via different network devices.

Configuring the functionality of the user device 206 accessible to the service provider may also or instead include configuring a functionality access policy for access of the service provider to at least one function provided by the user device 206. A function provided by the user device 206 may be considered to correspond to the obtaining of data by the user device 206, the processing of data obtained by the user device 206 and/or the sending of data from the user device 206 to a remote device, e.g. the computing system 222 associated with the service provider. Where the user device 206 is configured to perform a single function, e.g. if the user device 206 is a simple device such as a binary state-change sensor, configuring the functionality access policy may involve configuring whether the service provider is to be allowed or denied access to the function of the user device 206. Where the user device 206 is capable of performing a plurality of functions, though, the functionality access policy may be used to configure which of the plurality of functions (if any) the service provider is able to access. For example, the user device 206 may be configured (using a functionality access policy or otherwise), so that a first functionality of the user device is accessible to the service provider and a second functionality of the user device, different from the first functionality of the user device, is inaccessible to the service provider.

As an example, the user device 206 may be operable to obtain a plurality of different types of data, e.g. using a single sensor or a plurality of sensors. In such cases, the operation of the user device 206, and the data it obtains, may be altered by configuring the functionality of the user device 206. For example, with a first functionality, the user device 206 may obtain a single type of data, and with a second functionality, the user device 206 may obtain two different types of data. As an example, with the user device 206 configured to provide the first functionality, a first sensor captures data and a second sensor does not capture data. However, to provide the second functionality, both the first and second sensors of the user device 206 capture data, respectively. In such cases, the user device 206 may provide the data it obtains to the service provider irrespective of the type of data or which sensor the data is obtained by. In these cases, by configuring the functionality of the user device 206 itself, the functionality of the user device 206 that is accessible to the service provider is also configured. In other cases, the functionality of the user device 206 itself remains unchanged, but the functionality that is accessible to the user device 206 can be changed by configuring e.g. which types of data (or which portions of data) are provided by the user device 206 to the service provider.

In further examples, configuring the functionality of the user device 206 accessible to the service provider includes configuring settings of the user device 206 so that the user device 206 can connect to the service provider with appropriate settings. Such settings for example control or relate to sharing of data obtained by the user device 206 with the service provider, e.g. to ensure that the data is appropriately secured. In this way, the functionality of the user device 206 is made accessible to the service provider, but in a sufficiently secure manner.

The user device 206 may also or instead be configured to allow or disallow access of the service provider, e.g. via the computing system 222, to a further device connected to the user device 206, such as an endpoint device (which may be another user device in an IoT network). In such cases, configuring the functionality of the user device 206 involves configuring the behavior of the user device 206 as a gateway node. In cases in which the user device 206 acts as gateway node, control of the configuration of the user device 206 can be used to control access of the service provider to at least one further node (such as an endpoint device), e.g. to allow or disallow access to the at least one further node by the service provider. Control of access to an endpoint device may be enforced using an appropriate application programming interface (API).

The functionality of the user device 206 accessible to the service provider may be configured in various ways. In examples in which the response 218 from the node 216 includes the characteristic data, the characteristic data may be sent to a policy decision engine for determining the functionality of the user device 206 to be made accessible to the service provider. The policy decision engine may form part of the user device 206, the network device 204 or a further computing device. A suitable policy decision engine is the Usage Control Model (UCON) policy engine, which can be used to process the characteristic data (and in some cases further data, e.g. indicating whether the service provider complies with an accessibility condition) to determine the functionality of the user device 206, which is e.g. functionality that can be made accessible to the service provider without compromising a security of the system 200.

The policy decision engine may generate configuration instructions to configure the functionality of the user device 206 accessible to the service provider. The configuration instructions are for example sent from the policy decision engine to the user device 206 (directly or via at least one further device, such as the network device 204). The configuration instructions in these cases cause the configuring of the functionality of the user device 206, e.g. upon processing of the configuration instructions by a processor of the user device 206. In the example of FIG. 2, the network device 204 includes the policy decision engine, and sends the configuration instructions 226 to the user device 206. In other cases, though, the policy decision engine may generate a policy decision indicative of the functionality the user device 206 is to be configured with. The policy decision may be sent to a further unit, such as a configuration unit, for generation of the configuration instructions, which may then be sent to the user device 206.

FIG. 3 is schematic diagram of an example system 300 for storing characteristic data associated with a service provider. The characteristic data may be stored as described with reference to FIG. 3 before a user device is configured, e.g. as described with reference to FIG. 2.

The service provider sends attribute data 328 indicative of at least one attribute associated with the service provider to a verification system 330 configured to verify that the service provider has a particular characteristic. In this case, the attribute data 328 is sent to the verification system 330 using a computing system 322 associated with the service provider. The at least one attribute associated with the service provider is for example indicative of a service provided by the service provider, a policy of the service provider (e.g. indicating at least one security and/or data management policy implemented by the service provider) and may additionally or alternatively represent at least one feature of a configuration of the computing system 322, such as a software and/or hardware configuration of the computing system 322. The at least one attribute may indicate at least one operational attribute of the service provider and/or the computing system 322, e.g. from which the service provided by the service provider and/or the compliance of the service provider with a particular requirement can be determined. In general, the at least one attribute associated with the service provider may be or include any suitable attribute for use in assessing whether the service provider has a particular characteristic (which is e.g. a characteristic the verification system 330 is configured to verify). The attribute data 328 sent to the verification system 330 may hence depend on which characteristic the verification system 330 is configured to verify.

The verification system 330 in FIG. 3 is a system associated with a trusted authority, which is for example an entity that is generally regarded as being trustworthy, and which can be relied upon to accurately verify a particular characteristic. In some cases, the verification system 330 is associated with a regulatory authority, which may (although need not) be the same regulatory authority that issues or maintains a particular standard or regulation.

In FIG. 3, the verification system 330 receives the attribute data 328 from the computing system 322 associated with the service provider. However, in other examples, the verification system 330 may instead retrieve the attribute data from a different device or system. For example, the computing system 322 may send an identifier to the verification system 330, along with a request for verification of a characteristic associated with the service provider, e.g. verification of a service provided by the service provider and/or that the service provider complies with a particular requirement, such as a technical standard or legal requirement. The verification system 330 may then obtain the attribute data corresponding to the service provider (e.g. identified using the identifier received from the computing system 322) from a different device or system, and use the attribute data to verify the characteristic.

In FIG. 3, the verification system 330 is configured to process the attribute data to verify the characteristic associated with the service provider. This may involve, for example, determining whether the service provider provides a particular service and/or whether the service provider complies with a particular requirement, as discussed further above with reference to FIG. 2. In FIG. 3, the service provider does have a particular characteristic (e.g. the service provider does comply with a legal requirement such as GDPR), so the verification system 330 generates characteristic data indicative of a characteristic associated with the service provider. The characteristic data may be the same as or similar to the characteristic data described with reference to FIG. 2, and may hence represent or be derived from a certificate, and may be digitally signed by the verification system 330. Digital signing of the certificate allows third party entities (such as a network device or a user device) to verify that the characteristic data was generated by the verification system 330, e.g. as explained with reference to FIG. 2.

The characteristic data 332 is then sent from the verification system 330 to a node 316 of a DLN, for storing in a distributed ledger of the DLN. In FIG. 3, the node 316 sends an identifier 334 to the verification system 330, allowing the block of the distributed ledger in which the characteristic data is stored to be identified. The identifier 334 may for example be a block ID or a transaction ID for the distributed ledger. In this way, the characteristic data is stored in the distributed ledger.

Storage of the characteristic data in the distributed ledger by the verification system 330 may be considered to correspond to registering of the characteristic data in the distributed ledger. The distributed ledger stores the characteristic data immutably, meaning that subsequent changes in the characteristic data stored in the storage of the computing system 322 can be detected. In this way, a malicious third party cannot merely alter the characteristic data of the computing system 322 to gain access to particular functionality of a user device. With this approach, the trust of the verification system 330 is leveraged to generate (and store in the distributed ledger) characteristic data which is itself trustworthy. A user device can rely on the integrity of the characteristic data obtained from the distributed ledger because it was initially generated by a trustworthy entity (the verification system 330) and because it is resistant to modification, by virtue of its storage in the distributed ledger. This obviates the need for a service provider to send the attribute data to a user device each time the service provider wishes to obtain access to functionality of the user device. Instead, the user device can retrieve the characteristic data from the distributed ledger. The characteristic data can indicate that the service provider has a particular characteristic without including specific information about the service provider. Hence, using the characteristic data to determine a functionality the user device is to make accessible to the service provider may reduce the risk of sensitive information about the service provider (e.g. as represented by the attribute data) from being obtained by a malicious party. Moreover, it can be more efficient to obtain the characteristic data from the distributed ledger rather than from the verification system 330 itself (which may not have the capacity to deal with a high volume of requests). This is especially so, as the distributed ledger may be stored at a node that is physically closer to the verifying device.

In FIG. 3, the verification system 330 also sends a response 336 to the computing system 322, which in this case includes the characteristic data and the identifier 334. The characteristic data may be hashed or otherwise cryptographically secured before it is sent to the computing system 322 and/or the node 316. The characteristic data is then stored in storage of the computing system 322. The characteristic data may be stored in a digital wallet associated with the computing system 322, which is for example secure storage of or accessible to the computing system 322 for storing private information such as financial records. The computing system 322 can then provide the characteristic data to other devices or systems, such as a network device, for use in proving that the service provider has a particular characteristic.

A similar approach as that shown in FIG. 3 may be used to generate user authorization data associated with a user device, for use in authorizing a user device and/or to generate network device authorization data associated with a network device, for use in authorizing a network device. For example, user authorization data may be used to determine that the user device and/or a user of the user device is authorized to access a network of a network device before the network device grants access to the network to the user device. Similarly, network device authorization data may be used to determine that a network device is authorized to receive data obtained by a user device, e.g. for sending to the computing system 322, before the user device connects to or sends data to the network device.

For example, a user device may send user attribute data representative of at least one attribute of at least one of the user device or a user of the user device to a verification system. The verification system may be the same as or different from the verification system 330 for verifying the service provider. The verification system may use the user attribute data to determine whether at least one of the user device or the user device complies with a particular requirement, e.g. whether a configuration of the network device complies with a technical standard and/or legal requirement. If the user device is compliant, the verification system generates the user authorization data, which may represent or be otherwise derived from a certificate. The user device then receives the user authorization data from the verification system for use in authorizing at least one of the user device or the user device. The user device can then send the user authorization data to a further device, such as the network device, to allow the further device to authorize the user device. The verification system also sends the user authorization data to a node of a DLN, for the user authorization data to be added to a distributed ledger of the DLN.

In a similar way, a network device may send network device attribute data representative of at least one attribute of the network device to a verification system, which may be the same as or different from the verification system 330 for verifying the service provider. The verification system may use the network attribute data to determine whether the network device complies with a particular requirement, e.g. whether a configuration of the network device complies with a technical standard and/or legal requirement. If the network device is compliant, the verification system generates the network device authorization data, which may represent or be otherwise derived from a certificate. The network device then receives the network device authorization data from the verification system for use in authorizing the network device. The verification system also sends the network device authorization data to a node of a DLN, for the network device authorization data to be added to a distributed ledger of the DLN. The same distributed ledger may be used to store the characteristic data, the user device authorization data and/or the network device authorization data, or at least one of the characteristic data, the user device authorization data and the network device authorization data may be stored in a different respective distributed ledger.

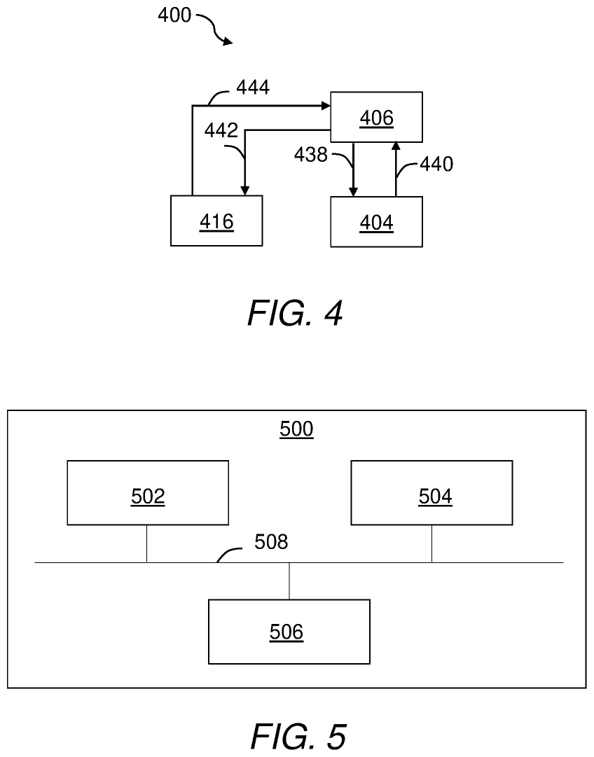

An example system 400 for authorizing a network device is shown schematically in FIG. 4. In FIG. 4, before a user device 406 makes functionality accessible to a service provider, via a network device 404, the user device 406 sends a request 438 to the network device 404 for network device authorization data. The network device 404 sends the network device authorization data 440 to the user device 406. The user device 406 also sends a request 442 to a node 416 of a DLN for a version of the network device authorization data stored in a distributed ledger of the DLN. The user device 406 receives the version of the network device authorization data 444 from the node 416. The user device 406 then validates the network device authorization data 440 against the version of the network device authorization data 444 to determine whether the network device 404 is authorized to provide functionality of the user device 406 to the service provider (which in this case involves the transfer of data from the user device 406 to the service provider via the network device 404). Validation of the network device authorization data 440 against the version of the network device authorization data 444 for example involves performing a comparison of the network device authorization data 440 and the version of the network device authorization data 444, to determine whether the network device authorization data 440 matches or is otherwise equal to the version of the network device authorization data 444.

If the user device 406 determines that the network device 404 is authorized, e.g. if the network device authorization data matches the version of the network device authorization data, and the version of the network device authorization data indicates that a configuration of the network device 404 satisfies a particular requirement, e.g. compliance with a technical standard and/or legal requirement, the user device 406 provides the functionality to the service provider, via the network device 404. Otherwise, the user device 406 ceases sending data to the network device 404, as this indicates that the network device 404 may have been compromised. In such cases, the service provider may access the functionality of the user device 406 via a different network device that is authorized.

FIG. 5 is a schematic diagram of internal components of a data processing system 500 that may be used in any of the methods described herein. The data processing system 500 may include additional components not shown in FIG. 5; only those most relevant to the present disclosure are shown. The data processing system 500 may be or form part of a network device (e.g. a gateway), a verification system, a user device, a node of a DLN, a computing system associated with a service provider, or a further computing device. The data processing system 500 in FIG. 5 is implemented as a single computer device but in other cases a data processing system may be implemented as a distributed system.

The data processing system 500 includes storage 502 which may be or include volatile or non-volatile memory, read-only memory (ROM), or random access memory (RAM). The storage 502 may additionally or alternatively include a storage device, which may be removable from or integrated within the data processing system 500. For example, the storage 502 may include a hard disk drive (which may be an external hard disk drive such as a solid state disk) or a flash drive. The storage 502 is arranged to store data, temporarily or indefinitely. The storage 502 may be referred to as memory, which is to be understood to refer to a single memory or multiple memories operably connected to one another.

The storage 502 may be or include a non-transitory computer-readable medium. A non-transitory computer-readable storage medium includes, but is not limited to, volatile memory, non-volatile memory, magnetic and optical storage devices such as disk drives, magnetic tape, compact discs (CDs), digital versatile discs (DVDs), or other media that are capable of storing code and/or data.

The data processing system 500 also includes at least one processor 504 which is configured to implement the methods described herein. The at least one processor 504 may be or comprise processor circuitry. The at least one processor 504 is arranged to execute program instructions and process data. The at least one processor 504 may include a plurality of processing units operably connected to one another, including but not limited to a central processing unit (CPU) and/or a graphics processing unit (GPU).

The data processing system 500 further includes a network interface 506 for connecting to at least one network, such as the local network 102 and the Internet 108 as shown in FIG. 1. A data processing system otherwise similar to the data processing system 500 of FIG. 5 may additionally include at least one further interface for connecting to at least one further component. The components of the data processing system 500 are communicably coupled via a suitable bus 508.

### Alternatives and Modifications

In the example of FIG. 1, the functionality of each of the user devices 106 in communication with the remote server 110 of the service provider is configured as described herein. However, this is merely an example and, in other cases, at least one user device in communication with a service provider need not be configured as described herein (e.g. if the functionality of the user device is relatively limited or non-sensitive). It is also to be appreciated that functionality of a user device may be provided to a different component associated with a service provider than a remote server, such as a different computing device associated with the service provider.

In the example of FIG. 3, the service provider has the particular characteristic so the verification system 330 generates the characteristic data. In other examples, the service provider lacks the particular characteristic the verification system 330 is configured to verify. In these examples, the verification system 330 for example issues a response to the computing system 322 associated with the service provider indicating that the service provider is non-compliant. The verification system 330 in this case does not generate characteristic data, so does not send data to the node 316 for storage in the distributed ledger. The service provider (or a system associated with the service provider such as the computing system 322) may then be reconfigured based on the response from the verification system 330. Such reconfiguration may be performed automatically. For example, the response from the verification system 330 may indicate further requirements for the computing system 322 to satisfy for the service provider to be considered to have a particular characteristic, such as the presence of particular software and/or hardware. In these cases, obtaining of additional software and/or hardware by the computing system 322 may be triggered by the response from the verification system 330. After the computing system 322 has been reconfigured appropriately (e.g. after additional software has been downloaded and installed), the computing system 322 may again send attribute data to the verification system 330. If the reconfigured computing system 322 is verified by the verification system 330 as having a particular characteristic, the verification system 330 generates characteristic data and sends the characteristic data to the node 316 and to the computing system 322.

It is to be appreciated that the present disclosure extends to a computer program comprising instructions which, when the computer program is executed by a computer, cause the computer to carry out any of the methods described herein. The present disclosure further extends to a computer-readable data carrier having stored thereon such a computer program, and to a data carrier signal carrying such a computer program.

Each feature disclosed herein, and (where appropriate) as part of the claims and drawings may be provided independently or in any appropriate combination.

Any reference numerals appearing in the claims are for illustration only and shall not limit the scope of the claims.

1. A method of configuring a user device, the method comprising:
sending, from the user device to a node of a distributed ledger network (DLN), the node configured to store a distributed ledger of the DLN, a request for characteristic data indicative of a characteristic associated with a service provider;
receiving, at the user device, a response from the node of the DLN in response to the request; and
configuring a functionality of the user device accessible to the service provider, based at least in part on the response from the node of the DLN.

2. The method according to claim 1, wherein configuring the functionality of the user device accessible to the service provider comprises configuring a data access policy for access of the service provider to data captured by the user device.

3. The method according to claim 1, wherein configuring the functionality of the user device accessible to the service provider comprises configuring a functionality access policy for access of the service provider to at least one function provided by the user device.

4. The method according to claim 1, wherein configuring the functionality of the user device accessible to the service provider comprises configuring the user device such that a first functionality of the user device is accessible to the service provider and a second functionality of the user device, different from the first functionality of the user device, is inaccessible to the service provider.

5. The method according to claim 1, wherein the user device comprises a sensor configured to capture sensor data indicative of at least one of: a feature of an environment of the user device or a feature of a user of the user device.

6. The method according to claim 5, wherein configuring the functionality of the user device accessible to the service provider comprises configuring the user device such that a first portion of the sensor data is accessible to the service provider and a second portion of the sensor data, different from the first portion of the sensor data, is inaccessible to the service provider.

7. The method according to claim 1, wherein the characteristic comprises at least one of: a service provided by the service provider, compliance of the service provider with a technical standard, or compliance of the service provider with a legal requirement.

8. The method according to claim 1, wherein the service provider is a first service provider, the functionality is a first functionality, and the method further comprises configuring the user device to make a second functionality of the user device, different from the first functionality, accessible to a second service provider, different from the first service provider.

9. The method according to claim 8, further comprising configuring the user device to provide the first functionality to the first service provider with the user device connected to a first network via a first network device, and configuring the user device to provide the second functionality to the second service provider with the user device connected to a second network via a second network device.

10. The method according to claim 1, wherein the response comprises the characteristic data, and the method further comprises sending the characteristic data to a policy decision engine for determining the functionality of the user device to be made accessible to the service provider.

11. The method according to claim 10, further comprising the user device receiving configuration instructions from the policy decision engine to cause the configuring of the functionality of the user device accessible to the service provider.

12. The method according to claim 1, wherein configuring the functionality of the user device accessible to the service provider comprises configuring the user device such that the functionality of the user device is accessible to the service provider upon compliance of the service provider with an accessibility condition.

13. The method according to claim 12, wherein the accessibility condition comprises connection of a computing system associated with the service provider, for communication with the user device, to a virtual private network (VPN) to which the user device is connected.

14. The method according to claim 1, wherein the characteristic data is first characteristic data, the response from the node of the DLN comprises the first characteristic data, and the method further comprises:
receiving, at the user device, second characteristic data from the service provider, the second characteristic data indicative of the characteristic associated with the service provider; and
configuring the functionality of the user device accessible to the service provider based at least in part on a comparison between the first characteristic data and the second characteristic data.

15. The method according to claim 1, wherein the characteristic data is indicative of a certificate associated with the service provider.

16. The method according to claim 1, wherein sending the request comprises sending the request via a network device, receiving the response comprises receiving the request via the network device, and the method further comprises:
the user device receiving network device authorization data from the network device for use in authorizing authorising the network device; and
the user device validating the network device authorization data against a version of the network device authorization data stored in the distributed ledger or a further distributed ledger.

17. The method according to claim 16, wherein the network device authorization data is indicative of a certificate associated with the network device.

18. The method according to claim 16, wherein the network device authorization data indicates that at least one of: a configuration of the network device complies with a technical standard or a configuration of the network device complies with a legal requirement.

19. The method according to claim 16, further comprising the user device validating the network device authorization data before configuring the functionality of the user device accessible to the service provider.

20. The method according to claim 16, wherein the network device comprises a gateway device.

21. The method according to claim 16, further comprising:
the user device sending user attribute data representative of at least one attribute of at least one of the user device or the user to a verification system; and
the user device receiving, from the verification system, user authorization data for use in authorizing authorising the at least one of the user device or the user.

22. The method according to claim 21, further comprising the user device sending the user authorization data to the network device for use in authorizing the at least one of: the user device or the user.

23. A data processing system comprising a processor configured to perform the method according to claim 1.

24. A network comprising:
a user device; and
a node of a distributed ledger network (DLN),
wherein the user device is configured to:
send a request for characteristic data indicative of a characteristic associated with a service provider to the node;
receive a response from the node of the DLN in response to the request; and
configure a functionality of the user device accessible to the service provider, based at least in part on the response from the node of the DLN, and
wherein the node of the DLN is configured to:
receive the request from the user device;
determine whether a distributed ledger of the DLN comprises the characteristic data;
generate the response for sending to the user device, wherein the response is indicative of whether the distributed ledger comprises the characteristic data; and
send the response to the user device.

25. A method of operating a network comprising a user device and a node of a distributed ledger network (DLN), the method comprising:
sending, from the user device to the node of the DLN, a request for characteristic data indicative of a characteristic associated with a service provider;
determining, at the node of the DLN, whether a distributed ledger of the DLN comprises the characteristic data;
generating, at the node of the DLN, a response indicative of whether the distributed ledger comprises the characteristic data;
sending the response from the node of the DLN to the user device; and
configuring a functionality of the user device accessible to the service provider, based at least in part on the response from the node of the DLN.
